(19) United States
(12) Patent Application Publication
(10) Pub. No.: US 2025/0272542 A1
(43) Pub. Date: Aug. 28, 2025

(54) METHODS AND APPARATUS FOR EFFICIENT WEIGHT ROUNDING OPTIMIZATION IN LARGE LANGUAGE MODEL (LLM) QUANTIZATION

(71) Applicant: Intel Corporation, Santa Clara, CA (US)

(72) Inventors: Wenhua Cheng, Shanghai (CN); Weiwei Zhang, Shanghai (CN); Haihao Shen, Shanghai (CN); Kaokao Lv, Shanghai (CN); Yiyang Cai, Shanghai (CN)

(21) Appl. No.: 18/586,183

(22) Filed: Feb. 23, 2024

(51) Int. Cl. G06N 3/0455; G06N 3/084

(52) U.S. Cl. CPC G06N 3/0455; G06N 3/084

(57) ABSTRACT

Example apparatus disclosed includes at least one memory, machine readable instructions, and programmable circuitry to at least one of instantiate or execute the machine readable instructions to determine a plurality of weights of a large language model, initialize a first parameter and a second parameter associated with the large language model, perform rounding quantization of the large language model weights using at least the first parameter or the second parameter, generate a quantized large language model using the large language model weights after the rounding quantization, determine model loss between the large language model and corresponding quantized large language model, and update the first parameter and the second parameter based on the model loss using backpropagation.

### FIELD OF THE DISCLOSURE

This disclosure relates generally to software processing, and, more particularly, to methods, systems, and apparatus for efficient weight rounding optimization in large language model (LLM) quantization.

### BACKGROUND

Large Language Models (LLMs) are used to perform artificial intelligence (AI)-based language-related tasks. Quantization methods that maintain accuracy while reducing computational costs associated with LLMs include weight-only quantization. Weight-only quantization is used to improve the efficiency of LLMs by broadening a quantization grid as the number of bits decreases, thereby emphasizing up and down rounding.

### BRIEF DESCRIPTION OF THE DRAWINGS

FIG. 1 is an example large language model (LLM) quantization and dequantization process using known rounding to nearest (RTN) quantization techniques.

FIG. 2 is an example LLM quantization, dequantization, and model loss minimization process performed in accordance with methods and apparatus disclosed herein.

FIG. 3 is an example pseudocode illustrating LLM-based weight rounding optimization of FIG. 2.

FIG. 4A illustrates example first results obtained using various quantization techniques applied in LLMs, including the quantization methods disclosed herein.

FIG. 4B illustrates example second results obtained using various quantization techniques applied in LLMs, including the quantization methods disclosed herein.

FIG. 5 is a block diagram representative of example weight rounding optimization circuitry that may be implemented in the example environment of FIG. 2.

FIG. 6 is a flowchart representative of example machine-readable instructions and/or example operations that may be executed, instantiated, and/or performed by example programmable circuitry to implement the example weight rounding optimization circuitry of FIG. 5.

FIG. 7 is a flowchart representative of example machine-readable instructions and/or example operations that may be executed, instantiated, and/or performed by example programmable circuitry to implement the example weight rounding optimization circuitry of FIG. 5 to compute gradients and reduce model loss in accordance with teachings disclosed herein.

FIG. 8 is a block diagram of an example processing platform including programmable circuitry structured to execute, instantiate, and/or perform the example machine readable instructions and/or perform the example operations of FIGS. 6-7 to implement weight rounding optimization circuitry of FIG. 5.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6 and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Large Language Models (LLMs), such as OpenAI Codex™ or ChatGPT™, represent deep learning algorithms that can be used to recognize, summarize, predict, and/or generate content using large datasets. Use of LLMs permits artificial intelligence (AI)-based models to generate human-like content. Model quantization is used to reduce the size of LLMs by modifying the precision of their weights. For example, quantization is a compression technique that reduces model size and improves inference efficiency by approximating floating-point numbers with smaller precision numbers. However, existing methods such as Quantization Aware Training (QAT) compromise either speed or accuracy. In particular, QAT is a resource-intensive fine-tuning process that necessitates the adjustment of hyperparameters. As such, quantization techniques capable of meeting the computational requirements of LLMs without compromising accuracy benefit efficiency while maintaining accuracy. While traditional quantization methods such as eight-bit quantization (W8A8) have been widely used, weight-only quantization provides a more practical option for reducing memory consumption associated with LLM's substantial memory requirements. For example, weight-only quantization is used to improve the efficiency of LLMs by broadening a quantization grid as the number of bits decreases, thereby emphasizing up and down rounding.

Other post-training quantization methods such as GPTQ quantize the weights group-by-group and adjust the remaining weights to compensate for quantization errors. This approach offers significant speed improvements compared to QAT. Additionally, compression can be applied layer-by-layer, resulting in a substantial reduction in memory usage. However, it is challenging to compensate substantial compression errors effectively. Other work in this area has explored trainable equivalent transformations to reduce quantization errors. While these methods have proven effective, they require an additional step to fold scaling, which can introduce performance overhead for certain models or limit their applicability to broader models. An alternative approach, SignRound, tunes the up-and-down rounding tasks using signed gradient descent. This method introduces no performance overhead and achieves substantial improvement of the results. However, SignRound only focuses on tuning the rounding tasks through perturbations.

Methods and apparatus disclosed herein achieve efficient weight rounding optimization in LLM-based quantization. In examples disclosed herein, block-wise optimization is used for tuning weight rounding associated with LLM-based quantization. Methods and apparatus disclosed herein outperform existing state-of-art methods by a large margin. Moreover, methods and apparatus disclosed herein do not introduce performance overhead during the inference phase and are applicable to all LLM-based models, as well as various deep learning domains such as Natural Language Processing (NPL) and computer vision. In examples disclosed herein, effectiveness of the rounding quantization operation associated with the rounding-to-nearest (RTN) method is enhanced through the introduction of three trainable parameters (e.g., α, β, and V). For example, incorporation of the trainable parameters improves the quantization and de-quantization of weights, resulting in a more adaptable and context-aware quantization process.

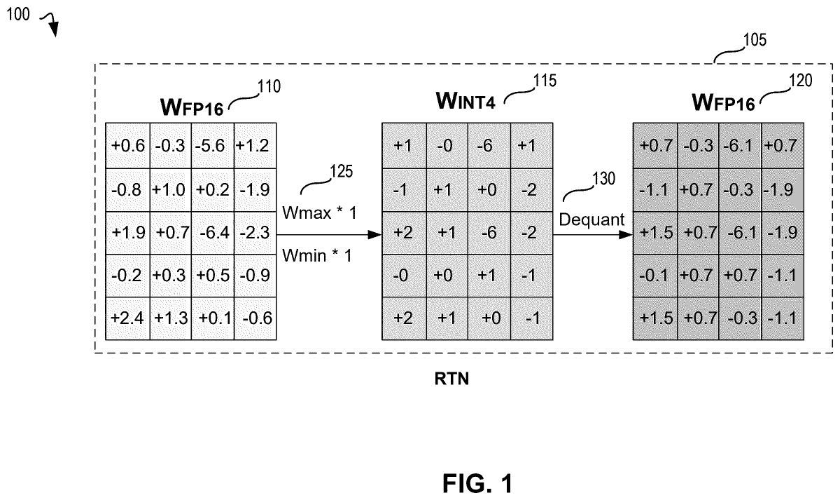

FIG. 1 is an example large language model (LLM) quantization and dequantization process 100 using a known rounding-to-nearest (RTN) quantization technique 105. For example, RTN is the predominant approach for neural network weight quantization, such that the weight vector (W) is rounded to the nearest quantization grid value in a fixed-point grid. The quantization and dequantization process 100 includes an example first grid of 16-bit floating point weights (W_{FP16}) 110, an example second grid of 4-bit integer weights (W_{INT4}) 115, and an example third grid of 16-bit integer weights (W_{FP16}) 120. Quantization of the first grid (W_{FP16}) 110 can be performed in accordance with Equations 1-2:

$$s = \frac{max ( W ) - min ( W )}{{2}^{bit} - 1} \qquad Equation 1$$

$$\tilde{W} = s * clip ⌊ \frac{W}{s} + zp ⌉ , n , m ) , n , m ∈ ℕ \qquad Equation 2$$

In the example of Equations 1 and 2, a rounding operation 125 is performed. In Equations 1 and 2, the variable s denotes the quantization scale with positive elements, max(W) represents the maximum weight value, and min(W) represents the minimum weight value of the first grid (W_{FP16}) 110. In Equation 2, the rounding operation is designated by ┌ ┐, and n and m represent the lower and upper bound for clipping. In examples disclosed herein involving four bits and asymmetric quantization, n is zero, m is 15(2\hat{ }4−1), and zp represents a zero point. The resulting quantized weights after the rounding operation are shown in the second grid (W_{INT4}) 115 of FIG. 1. For example, the RTN method quantizes each element independently by simply rounding it to the nearest integer (e.g., +0.6 becomes +1 and −0.3 becomes −0).

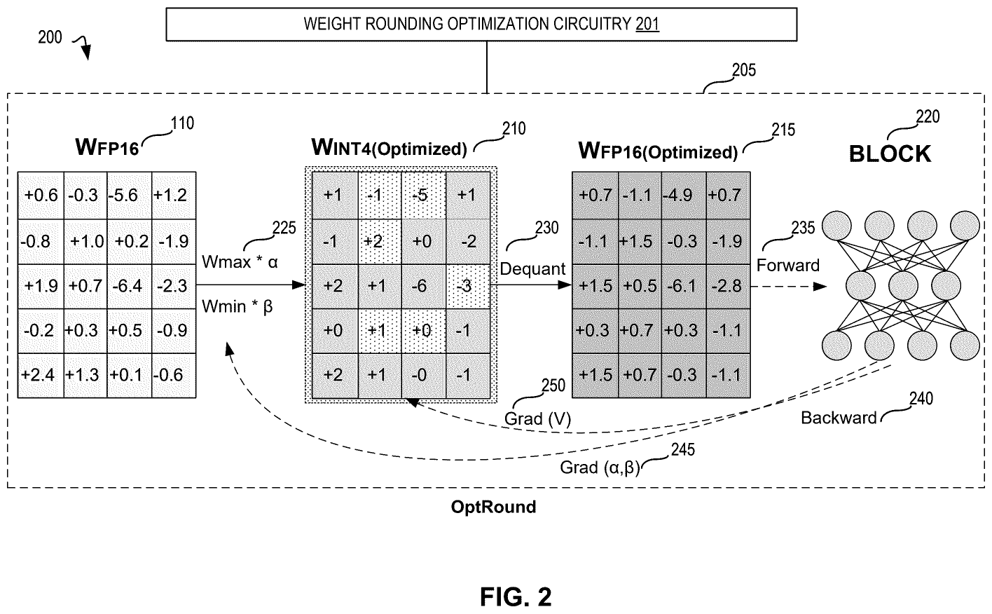

While the RTN technique 105 is concise, RTN quantizes each element independently and loses the compatibility of modeling the correction between different weights or activations. Subsequently, an example dequantization 130 is performed to obtain the third grid (W_{FP16}) 120 including dequantized weights W, in accordance with Equations 1-2 (e.g., the quantized weights are dequantized to 16-bit integer weights). Deployment of LLMs poses significant challenges due to considerable memory and storage requirements. Weight-only quantization emphasizes the importance of up and down rounding as the quantization grid broadens. Methods and apparatus disclosed herein focus on weight rounding optimization in LLM-based quantization for improved effectiveness of the rounding quantization operation, as described in more detail in connection with FIG. 2.

FIG. 2 is an example LLM quantization, dequantization, and model loss minimization process 200 performed in accordance with methods and apparatus disclosed herein using example weight rounding optimization circuitry 201. In the example of FIG. 2, the weight rounding optimization circuitry 201 performs a quantization rounding operation 205 to improve quantization operation efficiency. FIG. 2 includes the first grid of 16-bit floating point weights (W_{FP16}) 110, an example first optimized grid of 4-bit integer weights (W_{INT4}) 210, and an example second optimized grid of 16-bit integer weights (W_{FP16}) 215. In FIG. 2, the weight rounding optimization circuitry 201 performs an example block-wise output reconstruction 220 to generate lightweight forward and backward steps (e.g., forward step 235 and backward step 240), thereby optimizing the grid of 4-bit integer weights (W_{INT4}) 210 towards minimal loss (L), which is followed by a final inference deployment stage as part of the LLM (e.g., post-training). In the example of FIG. 2, the weight rounding optimization circuitry 201 generates gradients of trainable parameters during the backward step 240, including a first gradient 245 (e.g., Grad(α, β)) and a second gradient 250 (e.g., Grad(V)) used to update trainable parameters (e.g., α, β, V) associated with the quantization of the first grid of 16-bit floating point weights 110 and the dequantization of the first optimized grid of 4-bit integer weights 210, respectively. For example, the weight rounding optimization circuitry 201 performs quantization 225 using Equations 3 and 4, as shown below:

$$s = \frac{max ( W ) * α - min ( W ) * β}{{2}^{bit} - 1} \qquad Equation 3$$

$$\tilde{W} = s * clip ⌊ \frac{W}{s} + zp + V ⌉ , n , m ) , n , m ∈ ℕ \qquad Equation 4$$

In the example of Equations 3 and 4, three trainable parameters (e.g., a first parameter α, a second parameter β, and a third parameter V) are introduced to enhance the effectiveness of the rounding quantization operation. In examples disclosed herein, the first parameter α and the second parameter β control the minimum and maximum values of weights (W), as shown in connection with Equation 3, while the third parameter V directly modifies the rounding values, as shown in connection with Equation 4. For example, the weight rounding optimization circuitry 201 modifies the maximum weight value (max(W)) and the minimum weight value (min(W)) by the first parameter α and the second parameter β, respectively. Separately, the weight rounding optimization circuitry 201 modifies Equation 4 through the addition of the third parameter V. For example, to introduce more flexibility into the rounding operation, the third parameter V (e.g., a tensor) is introduced with the same shape of input weight W. In some examples, each element of V falls within the range of [−B, B](e.g., where B=0.5 to ensure that changes made only impact the rounding value). These adjustments allow for a more adaptable and context-aware quantization process.

In some examples, the weight rounding optimization circuitry 201 reconstructs the output of neural network layers, permitting loss (L) to be formulated in accordance with Equation 5:

$$L = {‖ WX - \tilde{W} X ‖}_{F}^{2} \qquad Equation 5$$

In Equation 5, the loss L is determined using the input weight (W) and the quantized weight (\tilde{W}), where X is the input of the neural network layer and ∥⋅∥_{F} denotes the Frobenius norm, where the Frobenius norm which is defined as the square root of the sum of the squares of all the matrix series (e.g., measuring the size of the matrix). The weight rounding optimization circuitry 201 performs an optimization using block-wise output reconstruction 220, such that the block-wise output reconstruction 220 trains the first, second, and/or third parameters (α, β, V), as shown in connection with Equation 6:

$$arg {min}_{α , β , V} {‖ WX - \tilde{W} X ‖}_{F}^{2} \qquad Equation 6$$

For example, the weight rounding optimization circuitry 201 uses Equation 6 to obtain a set of values corresponding to where the function attains the minimum values (e.g., using arg min) associated with the loss L identified in Equation 5. For example, LLM-based neural network model training uses targets to ensure that the model's output closely matches data labels. In particular, natural language processing (NLP)-based architectures such as LLM include the use of transformers, which rely on encoder-decoder networks. In examples disclosed herein, the weight rounding optimization circuitry 201 enforces the model's output to closely resemble the output of the original model (e.g., unquantized model), a process known as output reconstruction. Output reconstruction is performed to conserve memory by using a sub-model instead of the entire model, in a block-by-block manner. Furthermore, to ensure proper control over the range of α and β parameters, the weight rounding optimization circuitry 201 imposes constraints on these parameters, in accordance with Equation 7. In the example of Equation 7, the sigmoid function (sigmoid) transforms any value in the domain (−∞, ∞) to a number between 0 and 1, such that (s.t.) the first parameter α is constrained to a value between −1 and 0, as follows:

$$sigmoid ( 8 α + 4 ) , s . t . - 1 \leq α \leq 0 \qquad Equation 7$$

As compared to FIG. 1, FIG. 2 illustrates the optimized sections of the 4-bit integer weights grid (e.g., first optimized grid 210), where the values within the grid are updated from −0 and −6 (e.g., in the first row of grid 115) to −1 and −5 (e.g., in the first row of grid 210), respectively. In some examples, optimization can be performed by identifying weights that minimize a cost function by applying gradients via backpropagation to descent down the cost function until the minimum point and generate the weights associated with that minimum point.

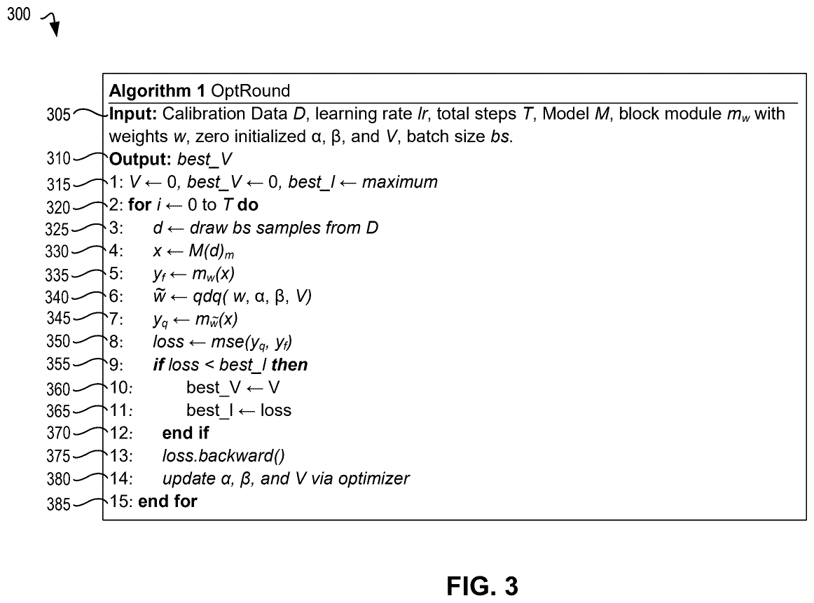

FIG. 3 is an example pseudocode 300 illustrating LLM-based weight rounding optimization (OptRound) of FIG. 2 using the weight rounding optimization circuitry 201. In the example of FIG. 3, the weight rounding optimization circuitry 201 receives input(s) corresponding to calibration data D associated with an LLM-based neural network model, learning rate lr, total training steps T (e.g., used in one iteration), Model M, block module m_{w} with weights w, zero initialized parameters (e.g., the first parameter α, the second parameter β, and the third parameter V described in connection with FIG. 2), as well as the batch size bs (e.g., number of training examples in one forward/backward pass) (e.g., at line 305). In the example of FIG. 3, the weight rounding optimization circuitry 201 outputs an optimized third parameter V (best_V) (e.g., at line 310). For example, the weight rounding optimization circuitry 201 sets the third parameter V to zero, the optimized parameter V_best to zero, and best_l (e.g., corresponding to loss) to maximum (e.g., at line 315). The weight rounding optimization circuitry 201 initiates a for loop to iterate over a sequence of training steps (T) until loss l is minimized.

For example, for training steps from i to T (e.g., at line 320), the for loop initiates parameters as follows: (1) batch size bs samples from the calibration data D are drawn and assigned to d (e.g., at line 325), (2) a function M(d)ₘ corresponding to model M outputs for d inputs is assigned to x (e.g., at line 330), (3) block module output for x inputs (m_{w}(x)) is assigned to y_{f} to obtain the output of the original module (e.g., at line 335), (4) quantization and dequantization (qdq) results obtained using weights w and parameters α, β, V are assigned to IT/in accordance with Equation 4 (e.g., at line 340), (5) an output of the quantized module is assigned to y_{q} (e.g., at line 345), and (6) the mean squared error mse of the quantized module output y_{q} and the block module output y_{f} is determined to identify loss in accordance with Equation 5 (e.g., at line 350). In the example of FIG. 3, the weight rounding optimization circuitry 201 initiates an if loop when the loss is determined to be less than the maximum loss value assigned to best_l (e.g., at line 355). For example, the if loop proceeds to assign V to best_V and assign loss to best_l (e.g., at lines 360-365), after which the if loop is completed. Likewise, the weight rounding optimization circuitry 201 computes gradient loss with respect to all parameters in the loss using loss.backward( ) (e.g., at line 375) and updates the first parameter α, the second parameter β, and the third parameter V using an optimizer (e.g., at line 380), before completing the for loop. In some examples, the loss.backward( ) function sets gradient attributes of all tensors with a true value in a corresponding computations graph, while the optimizer iterates that the list of parameters (e.g., tensors) received on initialization and subtracts the value of the tensor gradient. For example, the loss function and the optimizer assist in improving the performance of the model M, such that the loss function measures the difference between the predicted output of the model M and the actual output, while the optimizer adjusts the parameters to minimize the loss function.

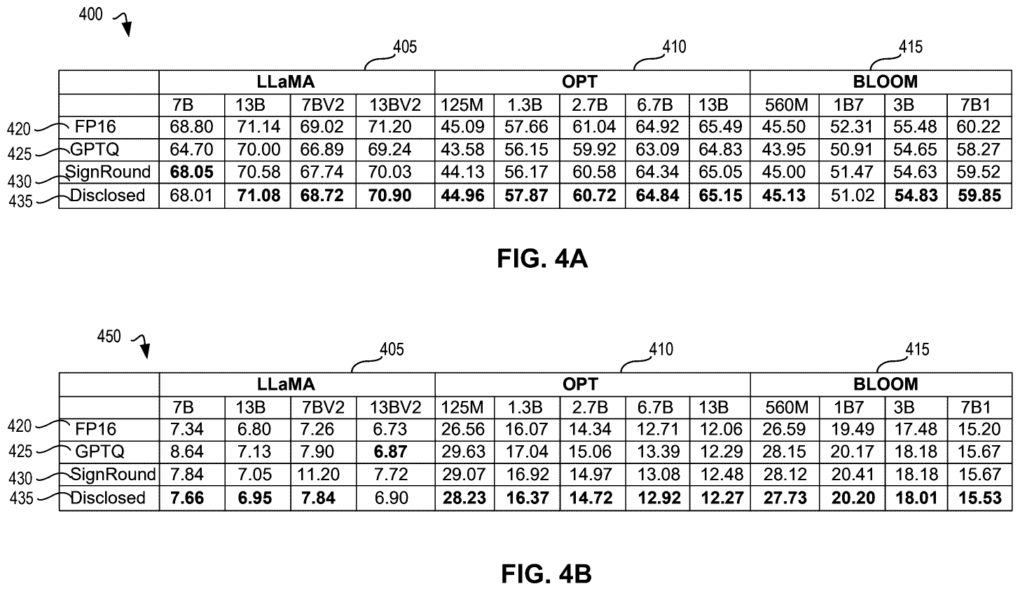

FIG. 4A illustrates example first results 400 obtained using various quantization techniques applied in Large Language Models (LLMs), including the quantization methods disclosed herein. FIG. 4B illustrates example second results 450 obtained using various quantization techniques applied in LLMs, including the quantization methods disclosed herein. In the example of FIGS. 4A-4B, three LLMs 405, 410, 415 are tested (e.g., LLaMA, OPT, and BLOOM) using various known quantization techniques 420, 425, 430 (e.g., FP16, GPTQ, SignRound) and compared to results obtained using methods and apparatus disclosed herein 435. For example, samples are selected randomly from pile-10k and truncated to a sequence length. In examples disclosed herein, GPTQ was followed to exclude the last layer of the network. Furthermore, a learning rate (lr) of 0.0025 was applied with a batch size of 8, a total sample size of 512, a sequence length (seq_len) of 512, and steps of 400. Additionally, a linear learning rate decay and an Adam optimizer with a weight decay of zero was applied for block tuning. However, any other hyperparameters can be used in addition to the hyperparameters disclosed herein. For example, an optimizer can be switched to sign gradient descent, setting the sequence length to 2048. In some examples, setting the sequence length can be optional.

In the example of FIGS. 4A-4B, various models of the LLMs were tested, including (1) LLaMA 7B, 13B, 7BV2, and 13BV2, (2) OPT 125M, 1.3B, 2.7B, 6.7B, and 13B, and (3) BLOOM 560M, 1B7, 3B, and 7B1. In particular, FIG. 4A results are associated with datasets tested using each of the LLMs 405, 410, 415, the datasets including HellaSwag, WinoGrand, PIQA and LAMBADA. In the example of FIG. 4A, the numbers generated are related to the obtained accuracy for each of the models, such that higher values correspond to greater accuracy of the quantization techniques 420, 425, 430, 435. Conversely, FIG. 4B results are associated with PPL of C4 datasets, such that lower values correspond to better accuracy of the quantization techniques 420, 425, 430, 435. The results confirm that methods and apparatus disclosed herein (e.g., disclosed 435) associated with the weight rounding optimization circuitry 201 of FIG. 2 show increases in accuracy when compared to known quantization techniques 420, 425, 430. Furthermore, methods and apparatus disclosed herein show significant enhancement in the pass rate (e.g., <1% loss in average accuracy across four tasks) (e.g., a 10/13 pass rate as compared to GPTQ's 0/13 pass rate). The approach used herein is lightweight (e.g., using only 400 tuning steps for each block) and introduces no performance overhead during the inference phase while also being applicable to all relevant models.

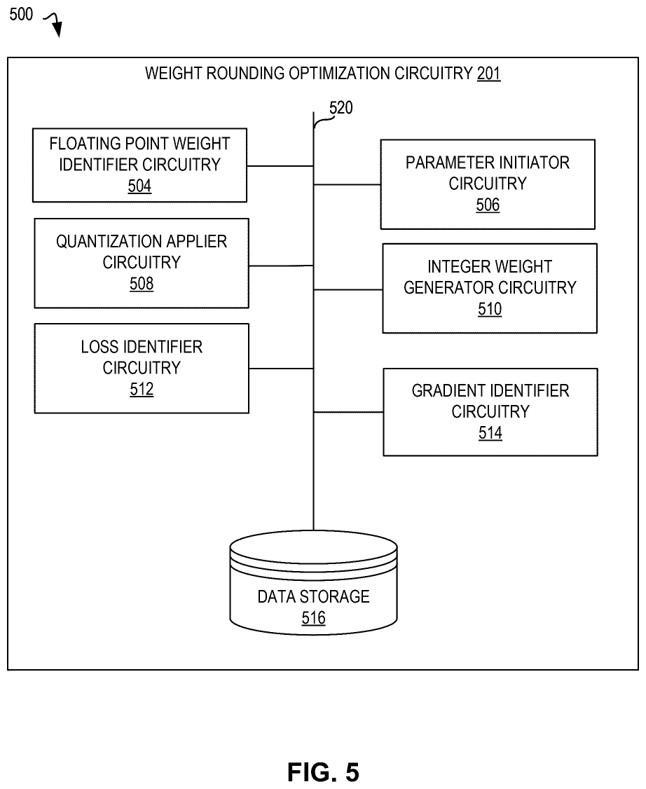

FIG. 5 is a block diagram of an example implementation of the weight rounding optimization circuitry 201 of FIG. 2. The weight rounding optimization circuitry 201 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the weight rounding optimization circuitry 201 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the example of FIG. 5, the weight rounding optimization circuitry 201 includes example floating point weight identifier circuitry 504, parameter initiator circuitry 506, quantization applier circuitry 508, integer weight generator circuitry 510, loss identifier circuitry 512, gradient identifier circuitry 514, and/or example data storage 516. In the example of FIG. 5, the floating point weight identifier circuitry 504, the parameter initiator circuitry 506, the quantization applier circuitry 508, the integer weight generator circuitry 510, the loss identifier circuitry 512, the gradient identifier circuitry 514, and/or the example data storage 516 are in communication via an example bus 520.

The floating point weight identifier circuitry 504 identifies floating point weights, such as the 16-bit floating point weights (W_{FP16}) associated with the first grid 110 of FIGS. 1 and 2. For example, the floating point weight identifier circuitry 504 identifies the 16-bit floating point weights prior to quantization, which involves model size reduction that converts model weights from high-precision floating-point representation to low-precision floating-point representation, promoting model-based inference speed and overall performance (e.g., in terms of bandwidth requirements and cache utilization). For example, the floating point weight identifier circuitry 504 identifies the initial input weights W associated with an original model.

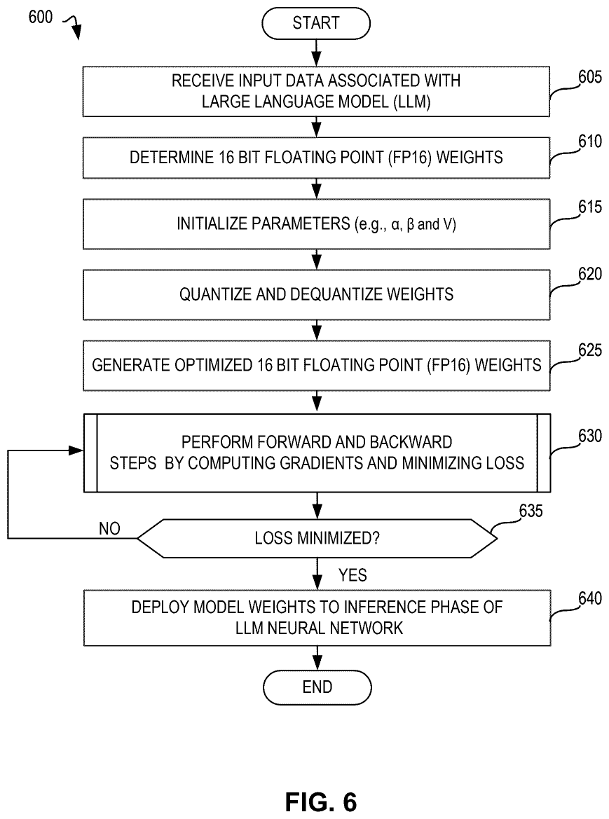

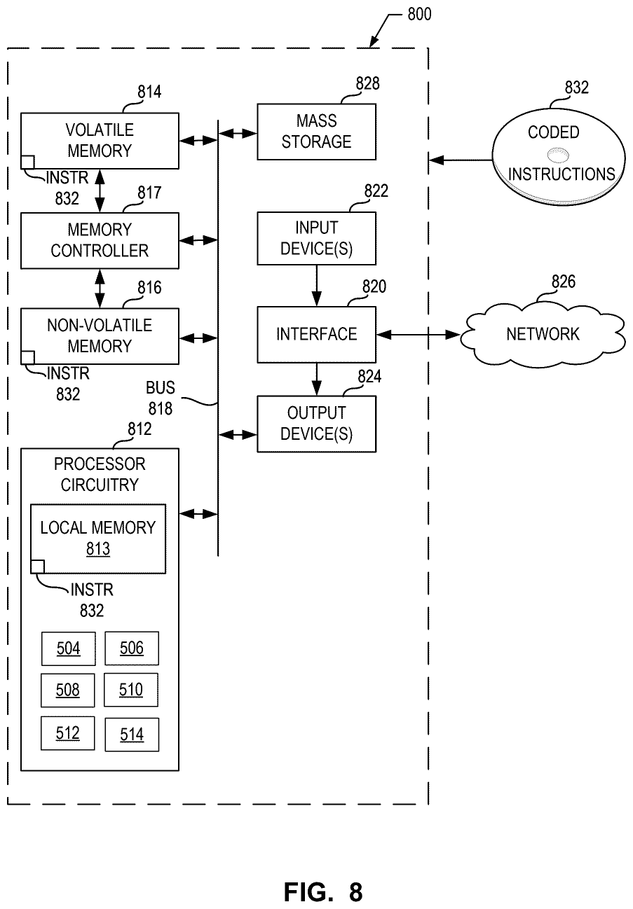

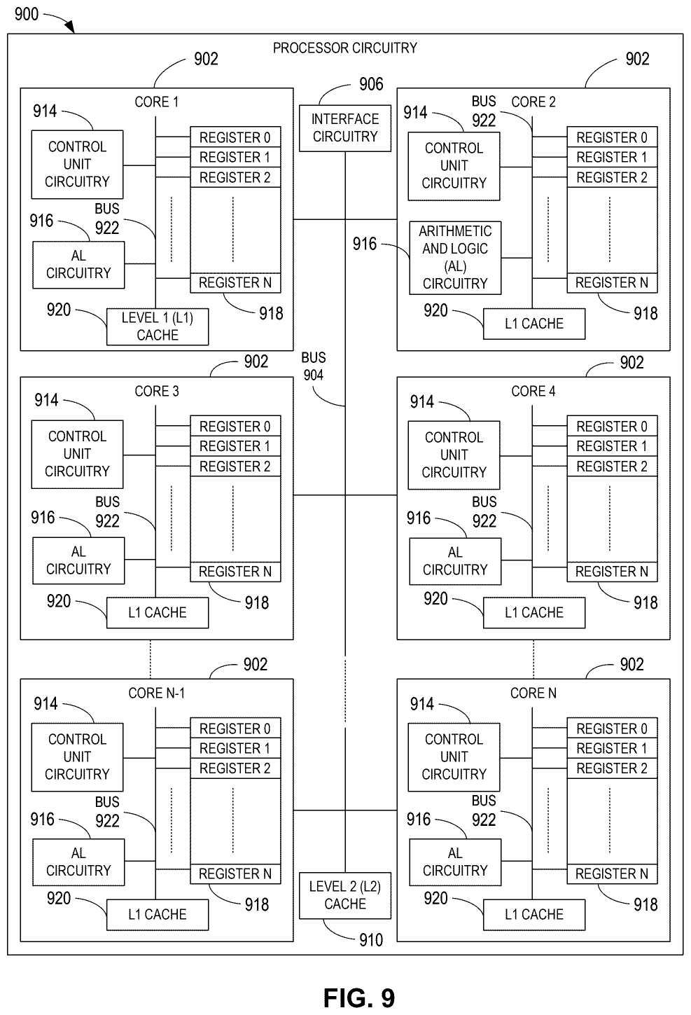

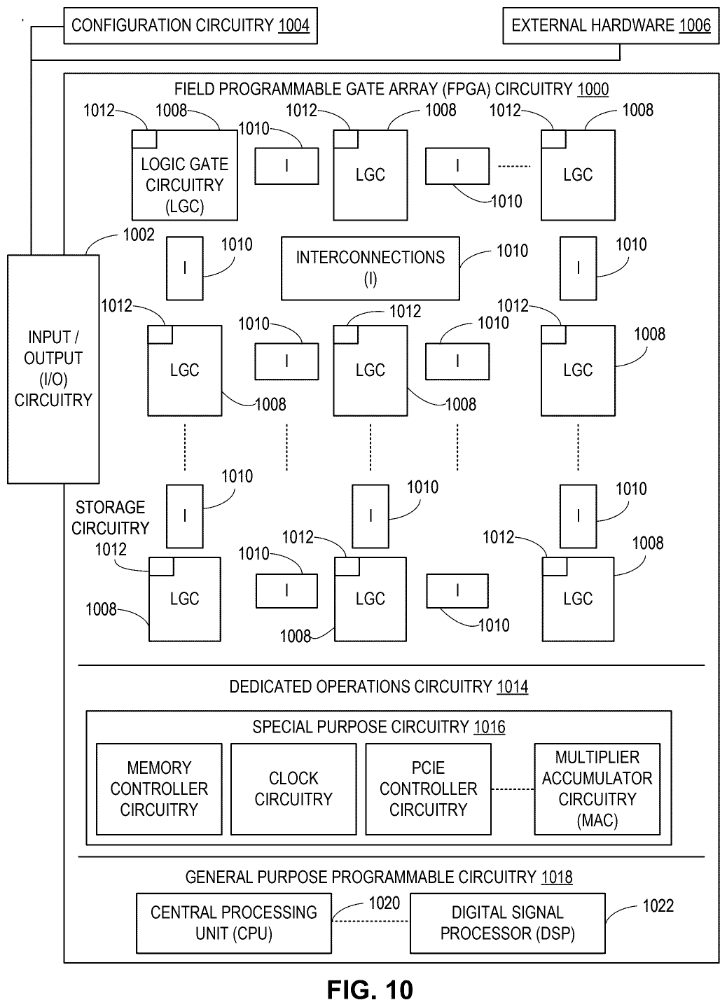

In some examples, the apparatus includes means for identifying floating point weights. For example, the means for identifying floating point weights may be implemented by floating point weight identifier circuitry 504. In some examples, the floating point weight identifier circuitry 504 may be instantiated by programmable circuitry such as the example programmable circuitry 812 of FIG. 8. For instance, the floating point weight identifier circuitry 504 may be instantiated by the example microprocessor 900 of FIG. 9 executing machine executable instructions such as those implemented by at least block 610 of FIG. 6. In some examples, the floating point weight identifier circuitry 504 may be instantiated by hardware logic circuitry, which may be implemented by an ASIC, XPU, or the FPGA circuitry 1000 of FIG. 10 structured to perform operations corresponding to the machine readable instructions. Additionally or alternatively, the floating point weight identifier circuitry 504 may be instantiated by any other combination of hardware, software, and/or firmware. For example, the floating point weight identifier circuitry 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The parameter initiator circuitry 506 identifies parameters (e.g., the first parameter α, the second parameter β, and the third parameter V) to enhance the effectiveness of the rounding quantization operation. In examples disclosed herein, the parameter initiator circuitry 506 initializes the first parameter α and the second parameter β to control the minimum and maximum values of the weights (W) identifies using the floating point weight identifier circuitry 504. Additionally, the parameter initiator circuitry 506 initializes a third parameter V to modify the rounding values associated with the first optimized grid of 4-bit integer weights (W_{INT4}) 210 of FIG. 2. For example, the parameter initiator circuitry 506 modifies the maximum weight value (max(W)) and the minimum weight value (min(W)) associated with the first grid 110 based on the parameters α and β, as described in connection with Equation 3. In some examples, the parameter initiator circuitry 506 initiates and/or assigns any other parameters (e.g., batch size, training steps, model output, etc.) associated with the weight rounding optimization described in connection with FIG. 3.

In some examples, the apparatus includes means for initiating parameters. For example, the means for initiating parameters may be implemented by parameter initiator circuitry 506. In some examples, the parameter initiator circuitry 506 may be instantiated by programmable circuitry such as the example programmable circuitry 812 of FIG. 8. For instance, the parameter initiator circuitry 506 may be instantiated by the example microprocessor 900 of FIG. 9 executing machine executable instructions such as those implemented by at least block 615 of FIG. 6. In some examples, the parameter initiator circuitry 506 may be instantiated by hardware logic circuitry, which may be implemented by an ASIC, XPU, or the FPGA circuitry 1000 of FIG. 10 structured to perform operations corresponding to the machine readable instructions. Additionally or alternatively, the parameter initiator circuitry 506 may be instantiated by any other combination of hardware, software, and/or firmware. For example, the parameter initiator circuitry 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The quantization applier circuitry 508 performs quantization and/or dequantization of the 16-bit floating point weights (W_{FP16}) associated with the first grid 110 of FIG. 2. For example, the quantization applier circuitry 508 performs quantization and dequantization (qdq, as shown in connection with FIG. 3) using weights W and parameters α, β, V, in accordance with Equation 4. In some examples, the quantization applier circuitry 508 modifies the weights of an input model M to take in a specific number of values without losing accuracy. In the example of FIG. 2, quantization results in the generation of the first optimized grid of 4-bit integer weights (W_{INT4}) 210, while dequantization results in the generation of the second optimized grid of 16-bit integer weights (W_{FP16}) 215.

In some examples, the apparatus includes means for applying quantization. For example, the means for applying quantization may be implemented by quantization applier circuitry 508. In some examples, the quantization applier circuitry 508 may be instantiated by programmable circuitry such as the example programmable circuitry 812 of FIG. 8. For instance, the quantization applier circuitry 508 may be instantiated by the example microprocessor 900 of FIG. 9 executing machine executable instructions such as those implemented by at least block 620 of FIG. 6. In some examples, the quantization applier circuitry 508 may be instantiated by hardware logic circuitry, which may be implemented by an ASIC, XPU, or the FPGA circuitry 1000 of FIG. 10 structured to perform operations corresponding to the machine readable instructions. Additionally or alternatively, the quantization applier circuitry 508 may be instantiated by any other combination of hardware, software, and/or firmware. For example, the quantization applier circuitry 508 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The integer weight generator circuitry 510 generates the 4-bit integer weights, such as the 4-bit integer weights (W_{INT4}) associated with the first optimized grid 210 of FIG. 2. For example, the integer weight generator circuitry 510 generates the 4-bit integer weights following quantization using the quantization applier circuitry 508, such that the 4-bit integer weight-based quantization can be used for reducing memory cost and latency while preserving model accuracy. As such, the storage and manipulation of data in a lower-precision format (e.g., 4-bit integers) instead of 32-bit floating-point numbers reduces the amount of memory required to store the model.

In some examples, the apparatus includes means for generating integer weights. For example, the means for generating integer weights may be implemented by integer weight generator circuitry 510. In some examples, the integer weight generator circuitry 510 may be instantiated by programmable circuitry such as the example programmable circuitry 812 of FIG. 8. For instance, the integer weight generator circuitry 510 may be instantiated by the example microprocessor 900 of FIG. 9 executing machine executable instructions such as those implemented by at least block 620 of FIG. 6. In some examples, the integer weight generator circuitry 510 may be instantiated by hardware logic circuitry, which may be implemented by an ASIC, XPU, or the FPGA circuitry 1000 of FIG. 10 structured to perform operations corresponding to the machine readable instructions. Additionally or alternatively, the integer weight generator circuitry 510 may be instantiated by any other combination of hardware, software, and/or firmware. For example, the integer weight generator circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The loss identifier circuitry 512 determines the loss function to apply to the LLM neural network layers. For example, the loss identifier circuitry 512 identifies the loss function L described in connection with Equation 5. For example, the loss L is determined using the input weights (W) and the quantized weights (W), as well as inputs X of the neural network layer. In examples disclosed herein, the loss function is applied as part of the block-wise output reconstruction 220 generating lightweight forward and backward steps (e.g., forward step 235 and backward step 240 of FIG. 2), thereby optimizing the grid of 4-bit integer weights (W_{INT4}) 210 towards a minimal loss, as described in connection with FIG. 3.

In some examples, the apparatus includes means for identifying a loss. For example, the means for identifying a loss may be implemented by loss identifier circuitry 512. In some examples, the loss identifier circuitry 512 may be instantiated by programmable circuitry such as the example programmable circuitry 812 of FIG. 8. For instance, the loss identifier circuitry 512 may be instantiated by the example microprocessor 900 of FIG. 9 executing machine executable instructions such as those implemented by at least block 630 of FIG. 6. In some examples, the loss identifier circuitry 512 may be instantiated by hardware logic circuitry, which may be implemented by an ASIC, XPU, or the FPGA circuitry 1000 of FIG. 10 structured to perform operations corresponding to the machine readable instructions. Additionally or alternatively, the loss identifier circuitry 512 may be instantiated by any other combination of hardware, software, and/or firmware. For example, the loss identifier circuitry 512 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The gradient identifier circuitry 514 determines gradients associated with the first parameter α, the second parameter β, and the third parameter V. For example, the gradient identifier circuitry 514 generates gradients during the backward step 240, including a first gradient 245 (e.g., Grad(α, β)) and a second gradient 250 (e.g., Grad(V)) used to update the parameters (e.g., α, β, V) associated with the quantization of the first grid of 16-bit floating point weights 110 and the dequantization of the first optimized grid of 4-bit integer weights 210, respectively. For example, the gradient identifier circuitry 514 applies gradients via backpropagation to descent down the cost function until the minimum point is reached (e.g., minimizing the loss function). In some examples, the gradient identifier circuitry 514 computes gradient loss with respect to all parameters in the loss function (e.g., using loss.backward( ), as described in connection with FIG. 3).

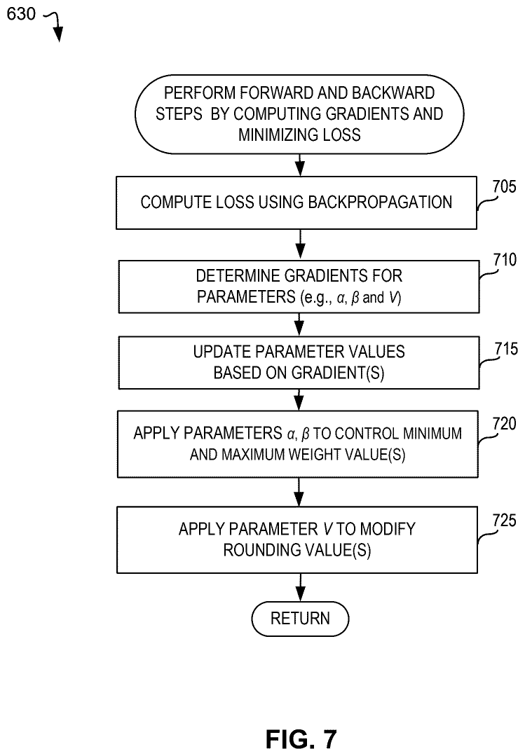

In some examples, the apparatus includes means for identifying a gradient. For example, the means for identifying a gradient may be implemented by gradient identifier circuitry 514. In some examples, the gradient identifier circuitry 514 may be instantiated by programmable circuitry such as the example programmable circuitry 812 of FIG. 8. For instance, the gradient identifier circuitry 514 may be instantiated by the example microprocessor 900 of FIG. 9 executing machine executable instructions such as those implemented by at least block 710 of FIG. 7. In some examples, the gradient identifier circuitry 514 may be instantiated by hardware logic circuitry, which may be implemented by an ASIC, XPU, or the FPGA circuitry 1000 of FIG. 10 structured to perform operations corresponding to the machine readable instructions. Additionally or alternatively, the gradient identifier circuitry 514 may be instantiated by any other combination of hardware, software, and/or firmware. For example, the gradient identifier circuitry 514 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 516 can be used to store any information associated with the floating point weight identifier circuitry 504, the parameter initiator circuitry 506, the quantization applier circuitry 508, the integer weight generator circuitry 510, the loss identifier circuitry 512, and the gradient identifier circuitry 514. The example data storage 516 of the illustrated example of FIG. 5 can be implemented by any memory, storage device and/or storage disc for storing data such as flash memory, magnetic media, optical media, etc. Furthermore, the data stored in the example data storage 516 can be in any data format such as binary data, comma delimited data, tab delimited data, structured query language (SQL) structures, image data, etc.

While an example manner of implementing the weight rounding optimization circuitry 201 of FIG. 2 is illustrated in FIG. 5, one or more of the elements, processes and/or devices illustrated in FIG. 5 may be combined, divided, re-arranged, omitted, eliminated and/or implemented in any other way. Further, the example floating point weight identifier circuitry 504, the parameter initiator circuitry 506, the quantization applier circuitry 508, the integer weight generator circuitry 510, the loss identifier circuitry 512, the gradient identifier circuitry 514, and/or, more generally, the example weight rounding optimization circuitry 201 of FIG. 2 may be implemented by hardware, software, firmware and/or any combination of hardware, software and/or firmware. Thus, for example, any of the example floating point weight identifier circuitry 504, the parameter initiator circuitry 506, the quantization applier circuitry 508, the integer weight generator circuitry 510, the loss identifier circuitry 512, the gradient identifier circuitry 514, and/or, more generally, the example weight rounding optimization circuitry 201 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the weight rounding optimization circuitry 201 of FIG. 2 may include one or more elements, processes, and/or devices in addition to, or instead of, those illustrated in FIG. 5, and/or may include more than one of any or all of the illustrated elements, processes and devices.

Flowcharts representative of example machine readable instructions, which may be executed by programmable circuitry to implement and/or instantiate the weight rounding optimization circuitry 201 of FIG. 2 and/or representative of example operations which may be performed by programmable circuitry to implement and/or instantiate the weight rounding optimization circuitry 201, are shown in FIGS. 6-7. The machine readable instructions may be one or more executable programs or portion(s) of one or more executable programs for execution by programmable circuitry, such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 6-7, many other methods of implementing the example weight rounding optimization circuitry 201 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed, instantiated, and/or performed by programmable circuitry to implement the example weight rounding optimization circuitry 201 of FIG. 2. The machine readable instructions and/or the operations 600 of FIG. 6 begin at block 605, at which the floating point weight identifier circuitry 504 receives input data associated with the large language model (LLM). For example, the floating point weight identifier circuitry 504 receives data associated with the model calibration data, the learning rate, the total training steps, the input block module weights, and/or the batch size, as described in connection with FIG. 3. The floating point weight identifier circuitry 504 identifies the 16 bit floating point (FP16) weights associated with the input data (e.g., input block module weights), at block 610. For example, the floating point weight identifier circuitry 504 identifies the first grid of 16-bit floating point weights (W_{FP16}) 110 of FIG. 2. The parameter initiator circuitry 506 proceeds to initialize parameters prior to quantization, at block 615. For example, the parameter initiator circuitry 506 initialized the first parameter α, the second parameter β, and/or the third parameter V. In some examples, the parameter initiator circuitry 506 assigns other parameters associated with optimized weight rounding, including, but not limited to, the batch size, the model M(d)ₘ outputs, and/or block module outputs, as described in connection with FIG. 3. The quantization applier circuitry 508 proceeds to quantize and/or dequantize the input weights (e.g., 16-bit floating point weights), at block 620. For example, the quantization applier circuitry 508 applies Equations 3-4 to the 16-bit floating point weights (W_{FP16}) 110 of FIG. 2, including the first parameter α, the second parameter β, and the third parameter V, to enhance the effectiveness of the rounding quantization operation. In response, the integer weight generator circuitry 510 generates the first optimized grid of 4-bit integer weights (W_{INT4}) 210 of FIG. 2 during quantization. Subsequently, the floating point weight identifier circuitry 504 generates the second optimized grid of 16-bit integer weights (W_{FP16}) 215 in response to the dequantization, at block 625. The loss identifier circuitry 512 proceeds to perform forward and backward steps by computing gradients and minimizing loss, at block 630. For example, the loss identifier circuitry 512 computes loss using backpropagation and/or applies gradients to modify the first parameter α, the second parameter β, and/or the third parameter V, as described in connection with FIG. 7. The loss identifier circuitry 512 determines whether the loss is minimized, at block 635. For example, the loss identifier circuitry 512 proceeds to minimize loss, as described in connection with FIG. 3. For example, the loss identifier circuitry 512 uses Equations 5-6 to obtain a set of values corresponding to where the function attains the minimum values (e.g., using arg min) associated with the loss L. Once the loss is minimized, the loss identifier circuitry 512 deploys the model weights to the interference phase of the LLM neural network, at block 640.

FIG. 7 is a flowchart representative of example machine readable instructions and/or example operations 630 that may be executed, instantiated, and/or performed by programmable circuitry to implement the example weight rounding optimization circuitry 201 of FIG. 2. The machine readable instructions and/or the operations 630 of FIG. 7 begin at block 705, at which the loss identifier circuitry 512 determines loss using backpropagation, as shown in the example of FIG. 2. For example, the loss identifier circuitry 512 generates lightweight forward and backward steps (e.g., forward step 235 and backward step 240 of FIG. 2), thereby optimizing the grid of 4-bit integer weights (W_{INT4}) 210 towards minimal loss (L). The gradient identifier circuitry 514 determines gradients associated with the first parameter α, the second parameter β, and the third parameter V, at block 710. For example, the gradient identifier circuitry 514 generates the first gradient 245 (e.g., Grad(α, β)) and the second gradient 250 (e.g., Grad(V)) used to update the parameters (e.g., α, β, V) associated with the quantization of the first grid of 16-bit floating point weights 110 and the dequantization of the first optimized grid of 4-bit integer weights 210, at block 715. For example, the gradient identifier circuitry 514 applies the parameters α, β to control minimum and maximum weight value(s), at block 720. Separately, the gradient identifier circuitry 514 applies the parameter V to modify the rounding value(s), at block 725.

FIG. 8 is a block diagram of an example programmable circuitry platform 800 structured to execute and/or instantiate the example machine-readable instructions and/or the example operations of FIGS. 6-7 to implement the example weight rounding optimization circuitry 201 of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs microprocessors, CPUs, GPUs, DSPs, and/or microcontrollers from any desired family or manufacturer. The programmable circuitry 812 may be implemented by one or more semiconductor based (e.g., silicon based) devices. In this example, the processor circuitry 812 implements the floating point weight identifier circuitry 504, the parameter initiator circuitry 506, the quantization applier circuitry 508, the integer weight generator circuitry 510, the loss identifier circuitry 512, and the gradient identifier circuitry 514.

The programmable circuitry 812 of the illustrated example includes a local memory 813 (e.g., a cache, registers, etc.). The programmable circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 800 of the illustrated example also includes one or more mass storage devices 828 to store software and/or data. Examples of such mass storage devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 832, which may be implemented by the machine readable instructions of FIGS. 6-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowcharts of FIGS. 6-7 to effectively instantiate the circuitry of FIG. 5 logic circuits to perform the operations corresponding to those machine readable instructions. In some such examples, the circuitry of FIG. 5 is instantiated by the hardware circuits of the microprocessor 900 in combination with the instructions. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6-7.

The cores 902 may communicate by a first example bus 904. In some examples, the first bus 904 may implement a communication bus to effectuate communication associated with one(s) of the cores 902. For example, the first bus 904 may implement at least one of an Inter-Integrated Circuit (I2C) bus, a Serial Peripheral Interface (SPI) bus, a PCI bus, or a PCIe bus. Additionally or alternatively, the first bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer-based operations. In other examples, the AL circuitry 916 also performs floating-point operations. In yet other examples, the AL circuitry 916 may include first AL circuitry that performs integer-based operations and second AL circuitry that performs floating point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 6-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 6-7. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 6-7. As such, the FPGA circuitry 1000 may be configured and/or structured to effectively instantiate some or all of the operations/functions corresponding to the machine readable instructions of the flowcharts of FIGS. 6-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 10. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 1002 of FIG. 10 may execute a first portion of the machine readable instructions represented by the flowchart(s) of FIGS. 6-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIGS. 6-7, and/or an ASIC may be configured and/or structured to perform third operation(s)/function(s) corresponding to a third portion of the machine readable instructions represented by the flowcharts of FIGS. 6-7.

It should be understood that some or all of the circuitry of FIG. 5 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 5 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 5 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8 which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

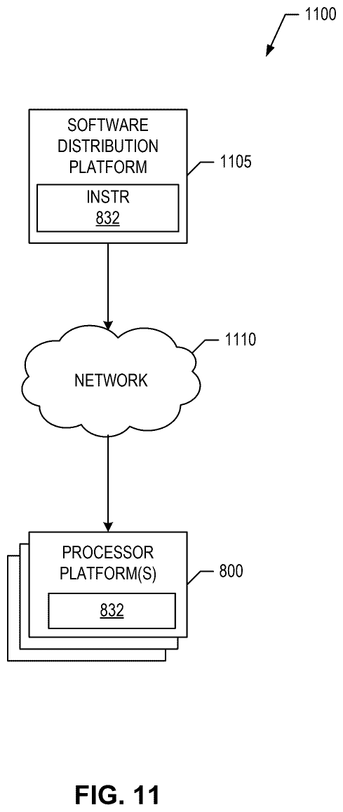

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6-7, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIGS. 6-7, may be downloaded to the example programmable circuitry platform 800, which is to execute the machine readable instructions 832 to implement the weight rounding optimization circuitry 201. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein achieve efficient weight rounding optimization in LLM-based quantization. In examples disclosed herein, block-wise optimization is used for tuning weight rounding associated with LLM-based quantization. Methods and apparatus disclosed herein are applicable to all LLM-based models, as well as various deep learning domains such as Natural Language Processing (NPL) and computer vision. In examples disclosed herein, effectiveness of the rounding quantization operation associated with the rounding-to-nearest (RTN) method is enhanced through the introduction of three trainable parameters (e.g., α, β, and V). For example, incorporation of the trainable parameters improves the quantization and de-quantization of weights, resulting in a more adaptable and context-aware quantization process. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for efficient weight rounding optimization in large language model (LLM) quantization are disclosed herein. Further examples and combinations thereof include the following:

Example 1 includes an apparatus comprising interface circuitry, machine readable instructions, and programmable circuitry to at least one of instantiate or execute the machine readable instructions to determine a plurality of weights of a large language model, initialize a first parameter and a second parameter associated with the large language model, perform rounding quantization of the large language model weights using at least the first parameter or the second parameter, generate a quantized large language model using the large language model weights after the rounding quantization, determine model loss between the large language model and corresponding quantized large language model, and update the first parameter and the second parameter based on the model loss using backpropagation.

Example 2 includes the apparatus of example 1, wherein the first parameter is associated with minimum weight values and the second parameter is associated with maximum weight values.

Example 3 includes the apparatus of example 1, further including a third parameter associated with modification of rounding values associated with the rounding quantization.

Example 4 includes the apparatus of example 3, wherein the programmable circuitry is to apply constraints on the first parameter, the second parameter, or the third parameter.

Example 5 includes the apparatus of example 3, wherein the programmable circuitry is to identify a first gradient associated with the first parameter, a second gradient associated with the second parameter, or a third gradient associated with the third parameter.

Example 6 includes the apparatus of example 1, wherein the programmable circuitry is to generate optimized four-bit integer (INT4) weights based on the rounding quantization.

Example 7 includes the apparatus of example 1, wherein the programmable circuitry is to perform dequantization to generate optimized sixteen-bit floating point (FP16) weights.

Example 8 includes a method comprising determining a plurality of weights of a large language model, initializing a first parameter and a second parameter associated with the large language model, performing, by at least one processor circuit programmed by at least one instruction, rounding quantization of the large language model weights using at least the first parameter or the second parameter, generating a quantized large language model using the large language model weights after the rounding quantization, determining, by one or more of the at least one processor circuit, model loss between the large language model and corresponding quantized large language model, and updating, by one or more of the at least one processor circuit, the first parameter and the second parameter based on the model loss using backpropagation.

Example 9 includes the method of example 8, wherein the first parameter is associated with minimum weight values and the second parameter is associated with maximum weight values.

Example 10 includes the method of example 8, further including a third parameter associated with modification of rounding values associated with the rounding quantization.

Example 11 includes the method of example 10, further including applying constraints on the first parameter, the second parameter, or the third parameter.

Example 12 includes the method of example 10, further including identifying a first gradient associated with the first parameter, a second gradient associated with the second parameter, or a third gradient associated with the third parameter.

Example 13 includes the method of example 8, further including generating optimized four-bit integer (INT4) weights based on the rounding quantization.

Example 14 includes the method of example 8, further including performing dequantization to generate optimized sixteen-bit floating point (FP16) weights.

Example 15 includes a non-transitory machine readable storage medium comprising instructions to cause programmable circuitry to at least determine a plurality of weights of a large language model, initialize a first parameter and a second parameter associated with the large language model, perform rounding quantization of the large language model weights using at least the first parameter or the second parameter. generate a quantized large language model using the large language model weights after the rounding quantization, determine model loss between the large language model and corresponding quantized large language model, and update the first parameter and the second parameter based on the model loss using backpropagation.

Example 16 includes the non-transitory machine readable storage medium of example 15, wherein the first parameter is associated with minimum weight values and the second parameter is associated with maximum weight values.

Example 17 includes the non-transitory machine readable storage medium as defined in example 15, further including a third parameter associated with modification of rounding values associated with the rounding quantization.

Example 18 includes the non-transitory machine readable storage medium as defined in example 17, wherein the instructions are to cause the programmable circuitry to apply constraints on the first parameter, the second parameter, or the third parameter.

Example 19 includes the non-transitory machine readable storage medium as defined in example 17, wherein the instructions are to cause the programmable circuitry to identify a first gradient associated with the first parameter, a second gradient associated with the second parameter, or a third gradient associated with the third parameter.

Example 20 includes the non-transitory machine readable storage medium as defined in example 15, wherein the instructions are to cause the programmable circuitry to generate optimized four-bit integer (INT4) weights based on the rounding quantization.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
interface circuitry;
machine readable instructions; and
programmable circuitry to at least one of instantiate or execute the machine readable instructions to:
determine a plurality of weights of a large language model;
initialize a first parameter and a second parameter associated with the large language model;
perform rounding quantization of the large language model weights using at least the first parameter or the second parameter;
generate a quantized large language model using the large language model weights after the rounding quantization;
determine model loss between the large language model and corresponding quantized large language model; and
update the first parameter and the second parameter based on the model loss using backpropagation.

2. The apparatus of claim 1, wherein the first parameter is associated with minimum weight values and the second parameter is associated with maximum weight values.

3. The apparatus of claim 1, further including a third parameter associated with modification of rounding values associated with the rounding quantization.

4. The apparatus of claim 3, wherein the programmable circuitry is to apply constraints on the first parameter, the second parameter, or the third parameter.

5. The apparatus of claim 3, wherein the programmable circuitry is to identify a first gradient associated with the first parameter, a second gradient associated with the second parameter, or a third gradient associated with the third parameter.

6. The apparatus of claim 1, wherein the programmable circuitry is to generate optimized four-bit integer (INT4) weights based on the rounding quantization.

7. The apparatus of claim 1, wherein the programmable circuitry is to perform dequantization to generate optimized sixteen-bit floating point (FP16) weights.

8. A method comprising:
determining a plurality of weights of a large language model;
initializing, by at least one processor circuit programmed by at least one instruction, a first parameter and a second parameter associated with the large language model;
performing, by one or more of the at least one processor circuit, rounding quantization of the large language model weights using at least the first parameter or the second parameter;
generating a quantized large language model using the large language model weights after the rounding quantization;
determining model loss between the large language model and corresponding quantized large language model; and
updating the first parameter and the second parameter based on the model loss using backpropagation.

9. The method of claim 8, wherein the first parameter is associated with minimum weight values and the second parameter is associated with maximum weight values.

10. The method of claim 8, further including a third parameter associated with modification of rounding values associated with the rounding quantization.

11. The method of claim 10, further including applying constraints on the first parameter, the second parameter, or the third parameter.

12. The method of claim 10, further including identifying a first gradient associated with the first parameter, a second gradient associated with the second parameter, or a third gradient associated with the third parameter.

13. The method of claim 8, further including generating optimized four-bit integer (INT4) weights based on the rounding quantization.

14. The method of claim 8, further including performing dequantization to generate optimized sixteen-bit floating point (FP16) weights.

15. A non-transitory machine readable storage medium comprising instructions to cause programmable circuitry to at least:
determine a plurality of weights of a large language model;
initialize a first parameter and a second parameter associated with the large language model;
perform rounding quantization of the large language model weights using at least the first parameter or the second parameter;
generate a quantized large language model using the large language model weights after the rounding quantization;
determine model loss between the large language model and corresponding quantized large language model; and
update the first parameter and the second parameter based on the model loss using backpropagation.

16. The non-transitory machine readable storage medium of claim 15, wherein the first parameter is associated with minimum weight values and the second parameter is associated with maximum weight values.

17. The non-transitory machine readable storage medium as defined in claim 15, further including a third parameter associated with modification of rounding values associated with the rounding quantization.

18. The non-transitory machine readable storage medium as defined in claim 17, wherein the instructions are to cause the programmable circuitry to apply constraints on the first parameter, the second parameter, or the third parameter.

19. The non-transitory machine readable storage medium as defined in claim 17, wherein the instructions are to cause the programmable circuitry to identify a first gradient associated with the first parameter, a second gradient associated with the second parameter, or a third gradient associated with the third parameter.

20. The non-transitory machine readable storage medium as defined in claim 15, wherein the instructions are to cause the programmable circuitry to generate optimized four-bit integer (INT4) weights based on the rounding quantization.
